(19) United States
(12) Patent Application Publication
(10) Pub. No.: US 2020/0207024 A1
(43) Pub. Date: Jul. 2, 2020

(54) SYSTEMS AND METHODS FOR ADDITIVE MANUFACTURING

(71) Applicant: Continuous Composites Inc., Coeur d'Alene, ID (US)

(72) Inventors: RACHAEL KATHLEEN MORRIS, Greenacres, WA (US); Ryan C. Stocket, Spokane, WA (US); Kyle Frank Cummings, Everett, WA (US)

(73) Assignee: Continuous Composites Inc., Coeur d'Alene, ID (US)

(21) Appl. No.: 16/723,001

(22) Filed: Dec. 20, 2019

Related U.S. Application Data
(60) Provisional application No. 62/845,556, filed on May 9, 2019.
(60) Provisional application No. 62/787,506, filed on Jan. 2, 2019.

(51) Int. Cl. B29C 64/393; B33Y 50/02; G06T 17/00

(52) U.S. Cl. CPC B29C 64/393; B33Y 10/00; G06T 17/00; B33Y 50/02

(57) ABSTRACT

A method of forming a composite structure with an additive manufacturing machine is disclosed. The method may include generating a vector field within a virtual model of the composite structure based on anticipated load conditions for the composite structure, and generating a plurality of NURBS curves inside the virtual model that have trajectories at least partially affected by the vector field. The method may further include selectively sequencing the plurality of NURBS curves to generate a tool path based on the analysis, and causing the additive manufacturing machine to discharge a path of composite material along the tool path.

### RELATED APPLICATIONS

This application is based on and claims the benefit of priority from U.S. Provisional Application Nos. 62/787,506 and 62/845,556 that were filed on Jan. 2, 2019 and May 9, 2019, respectively, the contents of both of which are expressly incorporated herein by reference.

### TECHNICAL FIELD

The present disclosure relates generally to manufacturing systems and methods and, more particularly, to systems and methods for additive manufacturing.

### BACKGROUND

Traditional additive manufacturing is a process of creating three-dimensional parts by depositing overlapping layers of material under the guided control of a computer. A common form of additive manufacturing is known as fused deposition modeling (FDM). Using FDM, a thermoplastic material is passed through and liquified within a heated print head. The print head is moved in a predefined trajectory (a.k.a., a tool path) as the material discharges from the print head, such that the material is laid down in a particular pattern and shape of overlapping 2-dimensional layers. The material, after exiting the print head, cools and hardens into a final form. A strength of the final form is primarily due to homogeneous properties of the particular thermoplastic material supplied to the print head and a 3-dimensional shape formed by the stack of 2-dimensional layers.

A recently developed improvement over traditional FDM manufacturing involves the use of continuous fibers embedded within material discharging from the print head. In particular, a matrix is supplied to the print head and discharged (e.g., extruded and/or pultruded) along with one or more continuous fibers also passing through the same head at the same time. The matrix can be a traditional thermoplastic matrix, a thermoset matrix (e.g., a UV-curable, thermal-curable, and/or two-part resin), a powdered metal, or a combination of any of these and other known matrixes. Upon exiting the print head, a cure enhancer (e.g., a UV light, an ultrasonic emitter, a heat source, a catalyst supply, etc.) is activated to initiate and/or complete curing of the matrix. This curing occurs almost immediately, allowing for unsupported structures to be fabricated in free space. And when fibers, particularly continuous fibers, are embedded within the structure, a strength of the structure may be multiplied beyond the matrix-dependent strength. An example of this technology is disclosed in U.S. Pat. No. 9,511,543 that issued to Tyler on Dec. 6, 2016 (“the '543 patent”).

A structure that is additively manufactured from continuous fibers, while having a strength-to-weight ratio that is higher than traditionally manufactured structures, may also have strength properties that are highly dependent on the layout of the continuous fibers within the structure. That is, properties of the structure may be anisotropic. Accordingly, care should be taken to properly design the fiber layout.

One approach to designing fiber layout within an additively manufactured structure is disclosed in U.S. Pat. No. 9,656,429 of Mantha et al. that issued on May 23, 2017 (“the '429 patent”). In particular, the '429 patent discloses the steps of receiving a model for a part that is to be printed from a matrix material and a fiber material, and using the model to determine a print head tool path for use during printing. The '429 patent further discloses the steps of generating a mesh of analytic elements within the model of the part (e.g., via conventional finite element analysis—FEA), and determining a trajectory of the fiber material through each of the analytic elements based on the tool path. The '429 patent additionally discloses using a computer processor to determine a performance of the part based on the fiber material trajectory, making a comparison of the performance against a reference performance, and using the comparison to generate a new tool path. The process is repeated until the comparison indicates an acceptable performance of the part.

While the approach disclosed in the '429 patent may ultimately be successful, it may be computationally complex, inaccurate, and time consuming. Specifically, it has been found that generating the mesh of analytic elements disclosed in the '429 patent is difficult to complete and often requires manual intervention by a highly skilled analyst. Thus, generating the mesh is very time consuming and often is the bottleneck of the entire design process. Errors that are introduced into the mesh generation process are propagated through and even multiplied during subsequent analysis. In addition, because the approach of the'429 patent starts with a generic tool path and applies no logic in determining a new tool path during each reiteration, it may take a significant number of iterations for the design to converge to an acceptable result.

The disclosed systems and methods are directed to overcoming one or more of the problems set forth above and/or other problems of the prior art.

### SUMMARY

In one aspect, the present disclosure is directed to a method of forming a composite structure with an additive manufacturing machine. The method may include generating a vector field within a virtual model of the composite structure based on anticipated load conditions for the composite structure, and generating a plurality of NURBS curves inside the virtual model that have trajectories at least partially affected by the vector field. The method may also include selectively sequencing the plurality of NURBS curves to generate a tool path based on the analysis, and causing the additive manufacturing machine to discharge a path of composite material along the tool path.

In another aspect, the present disclosure is directed to another method of forming a composite structure with an additive manufacturing machine. This method may include at least one of receiving and generating a virtual model for the composite structure, at least one of receiving and generating load conditions for the composite structure, generating a vector field within the virtual model based on the load conditions, and generating a plurality of NURBS curves inside the virtual model that are generally aligned with the vector field. The method may also include defining a plurality of analytic elements using the plurality of NURBS curves as boundaries of each of the plurality of analytic elements without modifying the virtual model, and analyzing performance of the virtual model based on the load conditions using the plurality of analytic elements. The method may further include selectively sequencing the plurality of NURBS curves to generate a tool path based on the analysis, and causing the additive manufacturing machine to discharge a path of composite material along the tool path.

### BRIEF DESCRIPTION OF THE DRAWINGS

FIG. 1 is a diagrammatic illustration of an exemplary disclosed additive manufacturing system;

FIG. 2 is a flowchart depicting an exemplary disclosed method that may be performed by the additive manufacturing system of FIG. 1;

FIG. 3 is an isometric illustration of an exemplary disclosed structure that may be manufactured by the additive manufacturing system of FIG. 1;

FIG. 4 is an enlarged-view isometric illustration of an exemplary disclosed portion of the structure of FIG. 3;

FIG. 5 is an isometric illustration of an exemplary disclosed layout of continuous fibers and load conditions within the structure of FIGS. 3 and 4;

FIG. 6 is an isometric illustration of an enlarged portion of FIG. 5;

FIG. 7 is a diagrammatic illustration of exemplary disclosed load conditions applied to a single fiber of the layout of FIG. 5;

FIG. 8 is a performance illustration resulting from the load conditions of FIG. 5;

FIG. 9 illustrates an exemplary disclosed GUI that may be utilized to adjust the load conditions of FIG. 6;

FIGS. 10A and 10B are isometric illustrations an exemplary portions of a model of the structure of FIG. 3; and

FIG. 11 is a flowchart depicting an exemplary alternative method that may be performed by the additive manufacturing system of FIG. 1.

### DETAILED DESCRIPTION

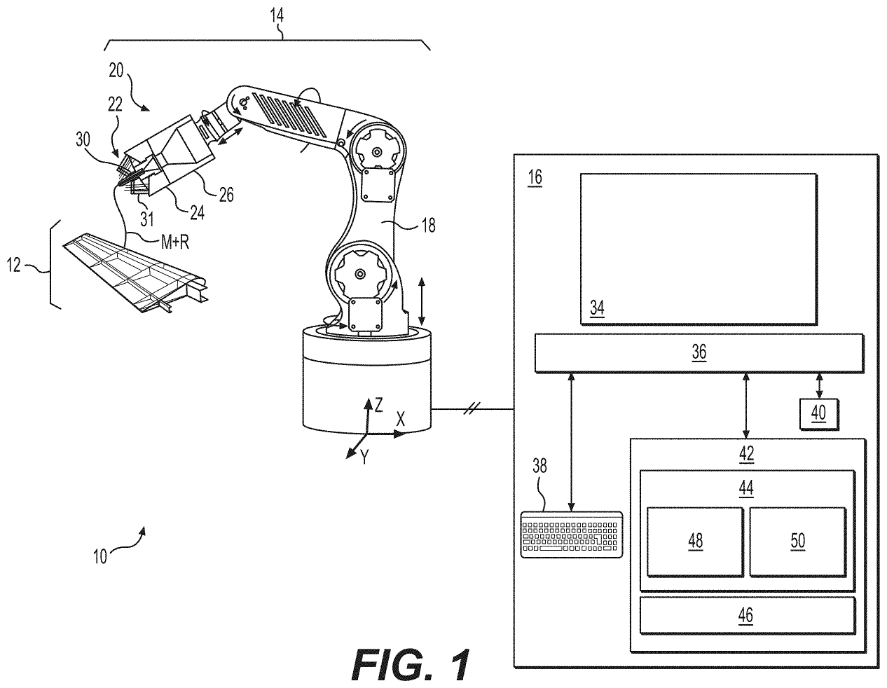

FIG. 1 illustrates an exemplary system 10, which may be used to design, plan, fabricate, and/or analyze a structure 12 having any desired shape, size, consist, and functionality. System 10 may include, among other things, an additive manufacturing machine (“machine”) 14 and at least one computing device 16 that is operatively connected to machine 14. Machine 14 may be configured to create structure 12 under the guided control of computing device 16, for example by way of an additive manufacturing process. Although additive manufacturing processes utilizing one or more continuous reinforcements (R) and one or more curable matrixes (M) will be described below as one example of how structure 12 may be created, it should be noted that other processes known in the art could alternatively be utilized for this purpose and benefit from the disclosed systems and methods.

Machine 14 may be comprised of components that are controllable to create structure 12, layer-by-layer and/or in free space (e.g., without the bracing of an underlying layer). These components may include, among other things, a support 18 and any number of heads 20 coupled to and powered via support 18. In the disclosed embodiment of FIG. 1, support 18 is a robotic arm capable of moving head 20 in multiple directions during fabrication of structure 12. It should be noted that any other type of support (e.g., an overhead gantry, an arm/gantry combination, etc.) capable of moving head 20 in the same or in a different manner could also be utilized, if desired. It is also contemplated that multiple supports 18 could be cooperatively controlled by computing device 16 to move any number of heads 20 during simultaneous fabrication of the same structure 12.

Each head 20 (only one shown in FIG. 1, for clarity) may be configured to discharge at least a matrix (e.g., a liquid resin, such as a zero volatile organic compound resin; a powdered metal; etc.) that is curable. Exemplary curable matrixes include thermosets, single- or multi-part epoxy resins, polyester resins, cationic epoxies, acrylated epoxies, urethanes, esters, thermoplastics, photopolymers, polyepoxides, thiols, alkenes, thiol-enes, and more. In one embodiment, the matrix inside each head 20 may be pressurized, for example by an external device (e.g., an extruder or another type of pump—not shown) that is fluidly connected to head 20 via a corresponding conduit (not shown). In another embodiment, however, the pressure may be generated completely inside of head 20 by a similar type of device. In yet other embodiments, the matrix may be gravity-fed through and/or mixed within head 20. In some instances, the matrix inside head 20 may need to be kept cool and/or dark to inhibit premature curing; while in other instances, the matrix may need to be kept warm for the same reason. In either situation, head 20 may be specially configured (e.g., insulated, temperature controlled, shielded, etc.) to provide for these needs.

In some embodiments, the matrix may be mixed with, contain, or otherwise coat one or more reinforcements (e.g., individual fibers, tows, rovings, sleeves, ribbons, and/or sheets of material) and, together with the reinforcements, make up at least a portion (e.g., a wall) of structure 12. The reinforcements may be stored within (e.g., on separate internal spools—not shown) or otherwise passed through head 20 (e.g., fed from external spools). When multiple reinforcements are simultaneously used, the reinforcements may be of the same type and have the same diameter and cross-sectional shape (e.g., circular, square, flat, etc.), or of a different type with different diameters and/or cross-sectional shapes. The reinforcements may include, for example, carbon fibers, vegetable fibers, wood fibers, mineral fibers, glass fibers, metallic wires, optical tubes, etc. It should be noted that the term “reinforcement” is meant to encompass both structural and non-structural types of continuous reinforcements that are at least partially encased in the matrix discharging from head 20.

The reinforcements may be exposed to (e.g., coated with) the matrix while the reinforcements are inside head 20, while the reinforcements are being passed to head 20, and/or while the reinforcements are discharging from head 20, as desired. The matrix, dry reinforcements, and/or reinforcements that are already exposed to the matrix (e.g., wetted fibers) may be transported into head 20 in any manner apparent to one skilled in the art.

Support 18 may move head 20 in a particular trajectory (e.g., a trajectory corresponding to an intended shape, size, and/or function of structure 12) at the same time that the matrix-coated reinforcements discharge from head 20, such that continuous paths of matrix-coated reinforcements are formed along the trajectory. Each path may have any cross-sectional shape, diameter, and/or reinforcement-to-matrix ratio, and the reinforcements may be radially dispersed with the matrix, located at a general center thereof, or located only at a periphery.

One or more cure enhancers (e.g., a UV light, an ultrasonic emitter, a laser, a heater, a catalyst dispenser, etc.) 22 may be mounted proximate (e.g., within or on) head 20 and configured to enhance a cure rate and/or quality of the matrix as it is discharged from head 20. Cure enhancer 22 may be regulated to selectively expose surfaces of structure 12 to energy (e.g., to UV light, electromagnetic radiation, vibrations, heat, a chemical catalyst or hardener, etc.) during the formation of structure 12. The energy may increase a rate of chemical reaction occurring within the matrix, sinter the matrix, harden the matrix, or otherwise cause the matrix to cure as it discharges from head 20. In the depicted embodiments, cure enhancer 22 includes one or more LEDs that are distributed (e.g., equally) about a center axis of head 20. However, it is contemplated that any number of LEDs or other energy sources could alternatively be utilized for the disclosed purposes and/or arranged in another manner (e.g., unequally distributed, arranged in a row, etc.). For example, cure enhancers 22 could be located on an arm (not shown) that trails behind head 20, if desired. The amount of energy produced by cure enhancer 22 may be sufficient to cure the matrix before structure 12 axially grows more than a predetermined length away from head 20. In one embodiment, structure 12 is completely cured before the axial growth length becomes equal to an external diameter of the matrix-coated reinforcement.

The matrix and reinforcements may be discharged from head 20 via at least two different modes of operation. In a first mode of operation, the matrix and reinforcements are extruded (e.g., pushed under pressure and/or mechanical force) from head 20, as head 20 is moved by support 18 to create the shape of structure 12. In a second mode of operation, at least the reinforcements are pulled from head 20, such that tensile stresses are created in the reinforcements during discharge that remain after curing of the matrix. In this mode of operation, the matrix may cling to the reinforcements and thereby also be pulled from head 20 along with the reinforcements, and/or the matrix may be discharged from head 20 under pressure along with the pulled reinforcements. In the second mode of operation, where the reinforcements are being pulled from head 20, the resulting residual tension in the reinforcements may increase a strength of structure 12, while also allowing for a greater length of unsupported material to have a straighter trajectory (i.e., the residual tension may act against the force of gravity to provide free-standing support for structure 12 and/or to resist buckling of the reinforcements).

The reinforcements may be pulled from head 20 as a result of head 20 moving away from an anchor point (not shown). For example, at the start of structure-formation, a length of matrix-impregnated reinforcement may be pulled and/or pushed from head 20, deposited onto the anchor point, and cured, such that the discharged material adheres to the anchor point. Thereafter, head 20 may be moved away from the anchor point, and the relative movement may cause the reinforcement to be pulled from head 20. It should be noted that the movement of reinforcements through head 20 could be assisted (e.g., via internal feed mechanisms), if desired. However, the discharge rate of reinforcements from head 20 may primarily be the result of relative movement between head 20 and the anchor point, such that tension is created within the reinforcements. It is contemplated that the anchor point could be moved away from head 20 instead of or in addition to head 20 being moved away from the anchor point.

As will be described in more detail below, it has been determined that a tension vector associated with each continuous reinforcement discharged by head 20 may contribute to a characteristic (e.g., a stiffness and/or strength) of structure 12. For example, a stiffness and/or strength of structure 12 may be generally greater in an axial direction of each reinforcement. Accordingly, during a pre-processing (e.g., design) phase and/or processing phase of fabricating structure 12, care may be taken to provide a desired amount, size, and/or shape of particular reinforcements in alignment with particular trajectories prior to and/or during curing, such that structure 12 performs according to required specifications.

Any number of separate computing devices 16 may be used to design and/or control the placement and residual tension of reinforcements within structure 12 and/or to analyze performance characteristics (e.g., stiffness, strength, and/or other characteristics) of structure 12 before and/or after formation. Computing device 16 may include, among other things, a display 34, one or more processors 36, any number of input/output (“I/O”) devices 38, any number of peripherals 40, and one or more memories 42 for storing programs 44 and data 46. Programs 44 may include, for example, any number of design and/or printing apps 48 and an operating system 50.

Display 34 of computing device 16 may include a liquid crystal display (LCD), a light emitting diode (LED) screen, an organic light emitting diode (OLED) screen, and/or another known display device. Display 34 may be used for presentation of data (e.g., performance of structure 12) under the control of processor 36.

Processor 36 may be a single or multi-core processor configured with virtual processing technologies, and use logic to simultaneously execute and control any number of operations. Processor 36 may be configured to implement virtual machine or other known technologies to execute, control, run, manipulate, and store any number of software modules, applications, programs, etc. In addition, in some embodiments, processor 36 may include one or more specialized hardware, software, and/or firmware modules (not shown) specially configured with particular circuitry, instructions, algorithms, and/or data to perform functions of the disclosed methods. It is appreciated that other types of processor arrangements could be implemented that provide for the capabilities disclosed herein.

Memory 42 can be a volatile or non-volatile, magnetic, semiconductor, tape, optical, removable, non-removable, or other type of storage device or tangible and/or non-transitory computer-readable medium that stores one or more executable programs 44, such as analysis and/or printing apps 48 and operating system 50. Common forms of non-transitory media include, for example, a flash drive, a flexible disk, a hard disk, a solid state drive, magnetic tape or other magnetic data storage medium, a CD-ROM or other optical data storage medium, any physical medium with patterns of holes, a RAM, a PROM, an EPROM, a FLASH-EPROM or other flash memory, NVRAM, a cache, a register or other memory chip or cartridge, and networked versions of the same.

Memory 42 may store instructions that enable processor 36 to execute one or more applications, such as design and/or fabrication apps 48, operating system 50, and any other type of application or software known to be available on computer systems. Alternatively or additionally, the instructions, application programs, etc. can be stored in an internal and/or external database (e.g., a cloud storage system—not shown) that is in direct communication with computing device 16, such as one or more databases or memories accessible via one or more networks (not shown). Memory 42 can include one or more memory devices that store data and instructions used to perform one or more features of the disclosed embodiments. Memory 42 can also include any combination of one or more databases controlled by memory controller devices (e.g., servers, etc.) or software, such as document management systems, Microsoft SQL databases, SharePoint databases, Oracle™ databases, Sybase™ databases, or other relational databases.

In some embodiments, computing device 16 is communicatively connected to one or more remote memory devices (e.g., remote databases—not shown) through a network (not shown). The remote memory devices can be configured to store information that computing device 16 can access and/or manage. By way of example, the remote memory devices could be document management systems, Microsoft SQL database, SharePoint databases, Oracle™ databases, Sybase™ databases, Cassandra, HBase, or other relational or non-relational databases or regular files. Systems and methods consistent with disclosed embodiments, however, are not limited to separate databases or even to the use of a database.

Programs 44 may include one or more software or firmware modules causing processor 36 to perform one or more functions of the disclosed embodiments. Moreover, processor 36 can execute one or more programs located remotely from computing device 16. For example, computing device 16 can access one or more remote programs that, when executed, perform functions related to disclosed embodiments. In some embodiments, programs 44 stored in memory 42 and executed by processor 36 can include one or more of design, fabrication, and/or analysis apps 48 and operating system 50. Apps 48 may cause processor 36 to perform one or more functions of the disclosed methods.

Operating system 50 may perform known operating system functions when executed by one or more processors such as processor 36. By way of example, operating system 50 may include Microsoft Windows™, Unix™, Linux™, OSX™, and IOS™ operating systems, Android™ operating systems, or another type of operating system 50. Accordingly, disclosed embodiments can operate and function with computer systems running any type of operating system 50.

I/O devices 38 may include one or more interfaces for receiving signals or input from a user and/or machine 14, and for providing signals or output to machine 14 that allow structure 12 to be printed. For example, computing device 16 can include interface components for interfacing with one or more input devices, such as one or more keyboards, mouse devices, and the like, which enable computing device 16 to receive input from a user.

Peripheral device(s) 40 may be standalone devices or devices that are embedded within or otherwise associated with machine 14 and used during fabrication of structure 12. Peripherals 40 can embody input devices (e.g., one or more sensors, such as tension sensors, position sensors, pressure sensors, temperature sensors, flow sensors, continuity sensors, humidity sensors, rotary encoders, and other sensors known in the art) and/or output devices (e.g., one or more actuators, such as a matrix supply, a reinforcement supply, a cooling device, a pump, cure enhancers 22, a positioning motor, a cutter, a splicer, a weaving mechanism, a reinforcement guide, a mixer, a feed roller, a tensioner, etc.). In some embodiments, peripherals 40 may, themselves, include one or more processors, a memory, and/or a transceiver. When peripheral device(s) 40 are equipped with a dedicated processor and memory, the dedicated processor may be configured to execute instructions stored on the memory to receive commands from processor 36 associated with video, audio, other sensory data, control data, location data, etc., including capture commands, processing commands, motion commands, and/or transmission commands. The transceiver may include a wired or wireless communication device capable of transmitting data to or from one or more other components in system 10. In some embodiments, the transceiver can receive data from processor 36, including instructions for sensor and/or actuator activation and for the transmission of data via the transceiver. In response to the received instructions, the transceiver can packetize and transmit data between processor 36 and the other components.

Design, fabrication, and/or analysis apps 48 may cause computing device 16 to perform methods related to generating, receiving, processing, analyzing, storing, and/or transmitting data in association with operation of machine 14 and corresponding design/fabrication/analysis of structure 12. For example, apps 48 may be able to configure computing device 16 to perform operations including: showing a graphical user interface (GUI) on display 34 for receiving design/control instructions and information from the operator of machine 14; capturing sensory data associated with machine 14 (e.g., via peripherals 40); receiving instructions via I/O devices 38 and/or the user interface regarding specifications, desired characteristics, and/or desired performance of structure 12; processing the control instructions; generating one or more possible designs of and/or plans for fabricating structure 12; analyzing and/or optimizing the designs and/or plans; providing recommendations of one or more designs and/or plans; controlling machine 14 to fabricate a recommended and/or selected design via a recommended and/or selected plan; analyzing the fabrication; and/or providing feedback and adjustments to machine 14 for improving future fabrications.

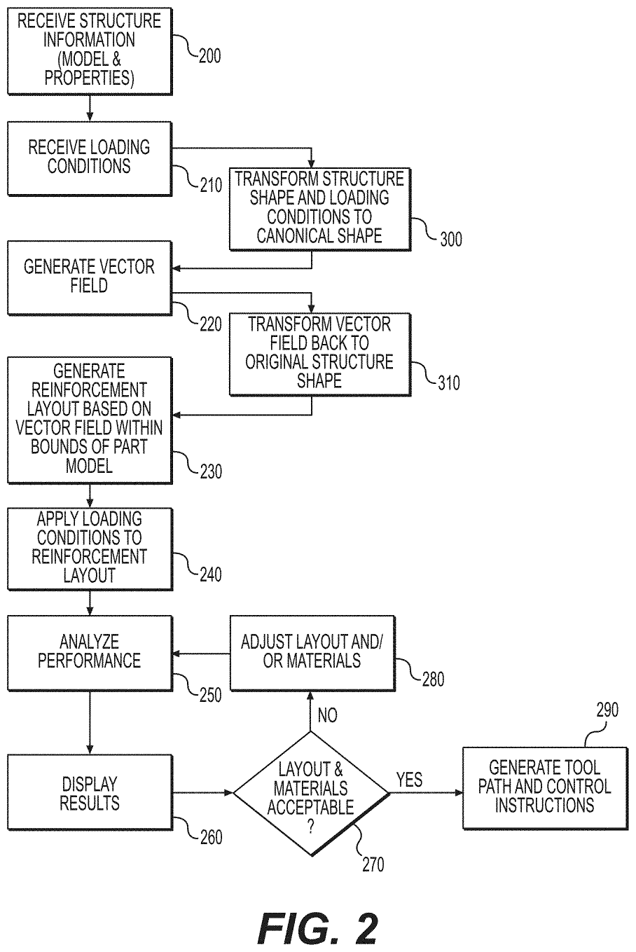

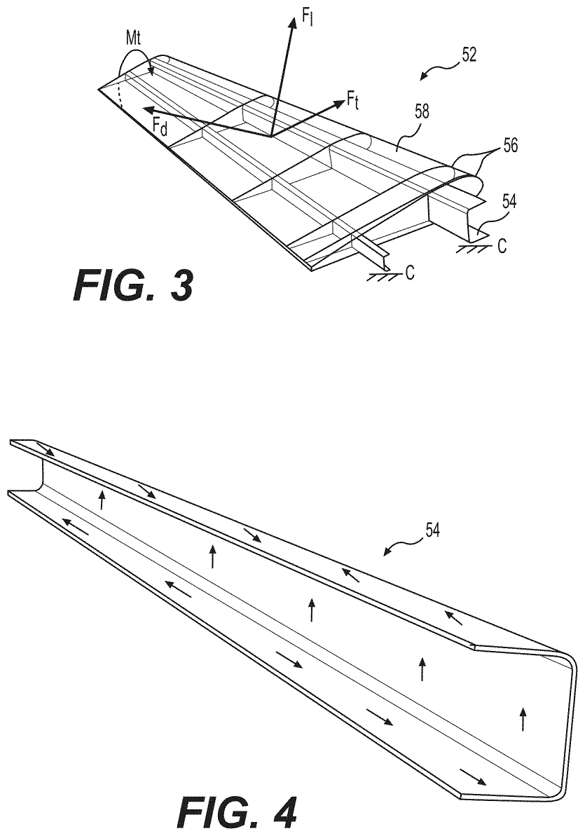

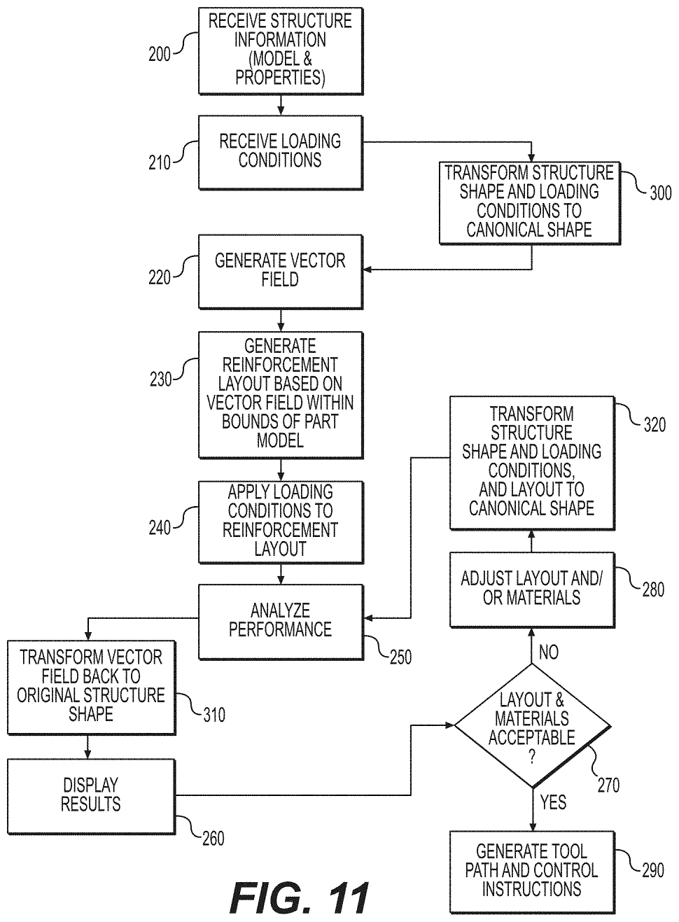

FIG. 2 is a flowchart depicting an exemplary method that may be implemented by computing device 16 during design, fabrication, and/or analysis of structure 12 by machine 14. FIGS. 3-10B represent various steps in the method of FIG. 2. FIG. 11 is another flowchart depicting an alternative exemplary method that may be implemented by computing device 16 during design, fabrication, and/or analysis of structure 12 by machine 14. FIGS. 2-11 will be discussed in detail in the following section to further illustrate the disclosed concepts.

### INDUSTRIAL APPLICABILITY

The disclosed systems may be used to continuously manufacture composite structures having any desired cross-sectional shape, length, density, stiffness, strength, and/or other characteristic. The composite structures may include any number of different reinforcements of the same or different types, diameters, shapes, configurations, and consists, and/or any number of different matrixes. Operation of system 10 will now be described in detail, with reference to FIGS. 2-10B.

As can be seen in the flowchart of FIG. 2, the creation of structure 12 may generally begin once information regarding structure 12 has been received into system 10 (Step 200). This information may include, among other things, a model 52 (e.g., a 1D, 2D or 3D model—shown in FIG. 3) of structure 12. Model 52 may be received as a collection of data that is interpretable by processor 36 using programs 44 (e.g., app 48), the data defining physical attributes (e.g., shape, size, orientation, materials, reinforcement density, reinforcement location, reinforcement orientation, etc.) of structure 12. Model 52 may be received by way of I/O devices 38 (referring to FIG. 1) or a network connection (e.g., from a conventional CAD module), retrieved by processor 36 from memory 42, and/or generated and modified by processor 36 and/or a user via programs 44.

In the example of FIG. 3, model 52 represents an airplane wing, at least a portion of which is to be fabricated by system 10. As is known in the art, a typical airplane wing generally consists of one or more spars 54, a plurality of intersecting ribs 56, and a skin 58 that is wrapped over spars 54 and ribs 56. For the purposes of this disclosure, the method of FIG. 2 will focus on spar 54.

During and/or after completion of Step 200, processor 36 may be configured to receive anticipated load conditions for structure 12 (Step 210). These load conditions may include, among other things, compression loads, tension loads, bending loads, torsion loads, thermal loads, environmental loads, and boundary conditions (e.g., constrained connections to other components). In the example of FIG. 3, the airplane wing is shown as being exposed to bending loads and torsion loads, resulting in local compression and tension load cases. The wing structure is also fixed to the aircraft wing-box or fuselage at the root end. In particular, a thrust force Fₜ is shown as acting at a general center of the wing (e.g., at a known engine mounting location) in a forward travel direction; a lift force Fₗ is shown as acting at the general center of the wing in a direction generally opposed to gravity; a drag force F_{d} is shown as acting at the general center of the wing in a direction generally opposite to a resultant of the lift force Fₗ and the thrust force Fₜ; a moment Mₜ is shown acting at an outer tip of the wing in a span-wise direction; and a constraint C is shown as being a boundary condition located at the inside end of the wing (i.e., at the fuselage connection location).

The load conditions may be received via I/O device(s) 38 in any manner known in the art. For example, they may be received via manual touching of display 34 or mouse-clicking at corresponding locations of model 52, and by drawing or otherwise entering force directions, force magnitudes, and boundary conditions (e.g., constraint types and coordinates). In another example, the force loads and/or boundary conditions may be automatically generated based on a known weight of the associated airplane, known traveling speeds, known engine locations and/or capacities, etc. In yet another embodiment, the loads and/or boundary conditions may be imported as one or more electronic files.

It should be noted that the model 52 received, generated and/or imported at Step 200 could first be partitioned before the loads and/or constraint conditions are applied, if desired. For example, it may be helpful in some situations to apply different load conditions to different partitions of model 52, while fully or partially isolating those partitions from other partitions. This may facilitate focused analysis of more critical parts of structure 12, with reduced computational effort.

Processor 36 may be configured to determine one or more vector field(s) through a particular component or partition of model 52 (Step 220). In one example, processor 36 may generate a force-based vector field (e.g., a constant linear field, a cylindrical field, a radial field, and/or a complex field of multiple types) through spar 54 based on a free-body diagram analysis of model 52, using the load conditions received at Step 210. This analysis may be simple and require little processing time and power, as high accuracy in these initial results may not be critical. As illustrated in FIG. 4, the vector field generated at Step 220 shows tensile forces resulting within a lower cap of spar 54, compressive forces resulting within an upper cap of spar 54, and shearing forces resulting within a web of spar 54.

In some embodiments, generation of the vector field may be customizable. Specifically, a user of system 10 may have the option of choosing different relationships governing how the vector field is to be generated. For example, the user may be able to select a decay rate of forces (or other parameters) within the field (e.g., based on a distance from an application location) or stipulate that the vector profile should be cylindrical, linear, and/or radial. In addition, each partition within model 52 may be assigned a standard or custom set of constants (e.g., material properties) that can affect vector field generation. It is also contemplated that the vector field(s) may be generated solely via user input (i.e., the user may be able to draw or otherwise place the vector field. Alternatively, after automatic generation of the vector field(s), the user may be able to manually adjust (e.g., push, pull, rotate, stretch, etc.) the field(s). In yet other embodiments, the vector field(s) may simply be imported from a file at Step 220.

In some embodiments, structure 12 may be complex and consume significant resources (e.g., time and/or computing resources) to create the vector field(s) described above. In addition, complex structures 12 could result in decreased accuracy in field generation and/or subsequent analysis. For this reason, in some embodiments, it may simplify the process to first map or otherwise transform the complex shape of structure 12 and the applied loading conditions into a simpler representation (e.g., a canonical shape such as a square, a circle, a sphere, etc.) that is easier to analyze. In one embodiment, this mapping is conformal (e.g., angle-maintaining at node points) (Step 300). In another example, this mapping is quasi-conformal (e.g., allowing some angle modification at node points, within established limits). During quasi-conformal mapping, the angle modification limits may be associated with parameters of intended-use materials (e g, minimum allowable bend radiuses of the reinforcements) and/or operational characteristics (e.g., minimum turning radiuses, z-steps, etc.) of machine 14. After transformation to the canonical shape, the vector field(s) may be generated and thereafter transformed back into the more complex shape of structure 12 (Step 310). It is contemplated that Steps 300 and 310 may be omitted, if desired.

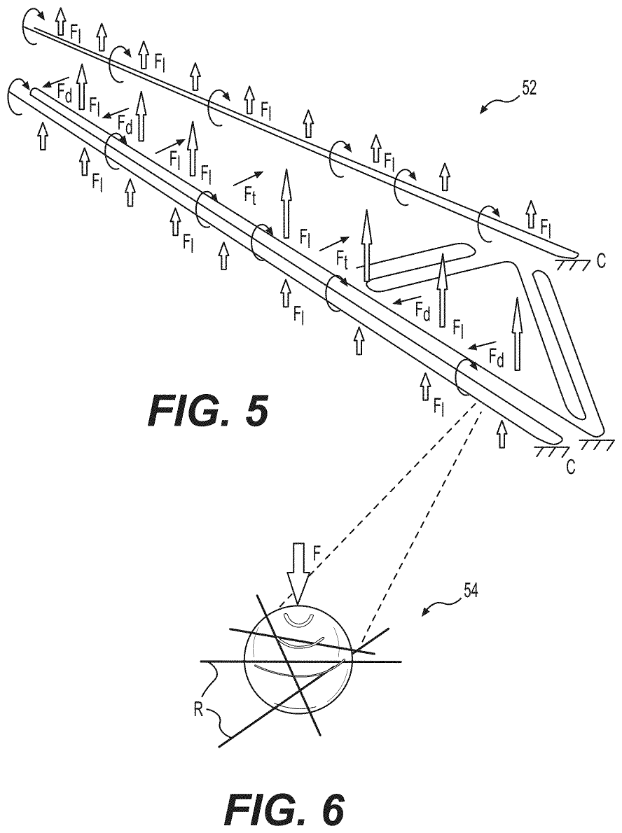

Processor 36 may be configured to generate a virtual layout (e.g., trajectories—shown in FIG. 5) of continuous reinforcements within model 52 of structure 12 based on the vector field generated at Step 220 and/or Step 310 (Step 230). Processor 36 may generate the layout by generally aligning trajectories of curves representing each individual reinforcement or tow of reinforcements with the field vectors inside model 52. It should be noted that the vector field(s) may be as coarse or refined as desired. However, when a coarser vector field is utilized, some interpolation between vectors within the field may be required when aligning the curve trajectories for a specified reinforcement density.

It should be noted that, in some embodiments, topography optimization may be implemented between Steps 220 and 230, if desired. In these embodiments, this optimization may result in reduced or otherwise modified geometry in which the continuous reinforcements may be laid out during completion of Step 230. The topography optimization may be implemented in any manner known in the art, where areas of lesser criticality (e.g., non-connection areas and/or areas that transfer lower levels of loading) may be omitted or reduced in size and/or shape.

At Step 230, the trajectory of each continuous reinforcement may be represented geometrically by way of one or more splines that are connected end-to-end. In particular, the splines may be used to directly represent each individual reinforcement or tow of reinforcements that is to be placed by system 10 within the boundaries of model 52. For example, a non-uniform rational basis spline (NURBS) may be a curve defined to have endpoints located at specified coordinates (e.g., at boundaries, intersections, and/or other nodes of the original model 52 provided to and/or generated by processor 36), and any number of control points along its length between the end points. The control points may either be connected directly to the associated curve or connected by way of an offset and/or resilient relationship. The trajectory of each NURBS curve can be adjusted via selective movement of the control points and/or modification of the number of control points within a given curve. Conventional software tools are available for use in generating NURBS curves during structural modeling. It should be noted that a geometric description of an underlying functional representation can be extracted from each NURBS curve and used in computations, as will be described below, without having to modify the description. In other words, model 52 may not need to be recreated and/or meshed into geometrical shapes each time an analysis of the model 52 fails to achieve required specifications.

Once the layout of continuous reinforcements within model 52 has been determined and the associated NURBS curves defined, processor 36 may translate and/or transform (e.g., move and/or distribute) the loads applied generally to structure 12 at Step 220 to individual reinforcements (Step 240—See FIG. 6). For example, the rotational moment Mₜ and the rearward drag force F_{d} may be distributed across the lengths of the individual reinforcements within the upper and lower caps of spar 54; the thrust force Fₜ may be applied to middle sections of the reinforcements within the web of spar 54; the lift force Fₜ may be distributed across the lengths of the individual reinforcements within the web; and the inside ends of the reinforcements within the upper cap, lower cap, and web may be constrained from movement.

In one example, point, line, and/or surface loads may be translated to individual reinforcements based on a proximity to the original application site and/or a magnitude of the loads. In particular, as shown in FIG. 6, the loads may be considered to disperse through a finite volume V of model 52 in a general direction of the vector field. A dispersion and/or dissipation rate of the load may be determined, at least in part, based on a type of matrix used in the volume, a type and configuration (e.g., size, shape, etc.) of reinforcements used within the volume, a density of the reinforcements, and an orientation of the reinforcements. As shown in FIG. 6, reinforcements closer to a load application site may experience a greater magnitude of the load over a shorter length (e.g., as represented by a length and thickness of the curved lines). In addition, each reinforcement may experience a different type of force (e.g., tensile force, compressive force, shearing force, etc.) based on the relative orientation between the reinforcement and the force vector.

After translation and/or transformation of the applied loads, each of the individual reinforcements (e.g., NURBS curves) may then be analyzed (Step 250), for example based on known properties of the reinforcements, to determine reactions to the forces within the individual reinforcements. In particular, as is known in the art, the performance of a composite structure is primarily dependent on performance of the individual reinforcements within the structure (e.g., as long as a low matrix-to-reinforcement ratio and curing of matrix surrounding the reinforcements is provided)—the matrix between the reinforcements contributes less to the performance. It should be noted that the known properties of the reinforcements used by processor 36 at Step 250 may, in some instances, include properties of the matrix immediately surrounding the reinforcements. In addition, the known properties of the reinforcements may include interactions between adjacent reinforcements due to spacings between the reinforcements and properties of the matrix within the spacings. It should be noted that the analysis of Step 250 may be performed without having to do any additional modeling (e.g., finite element meshing), data converting, or otherwise making any changes to the NURBS curves or underlying functional representations.

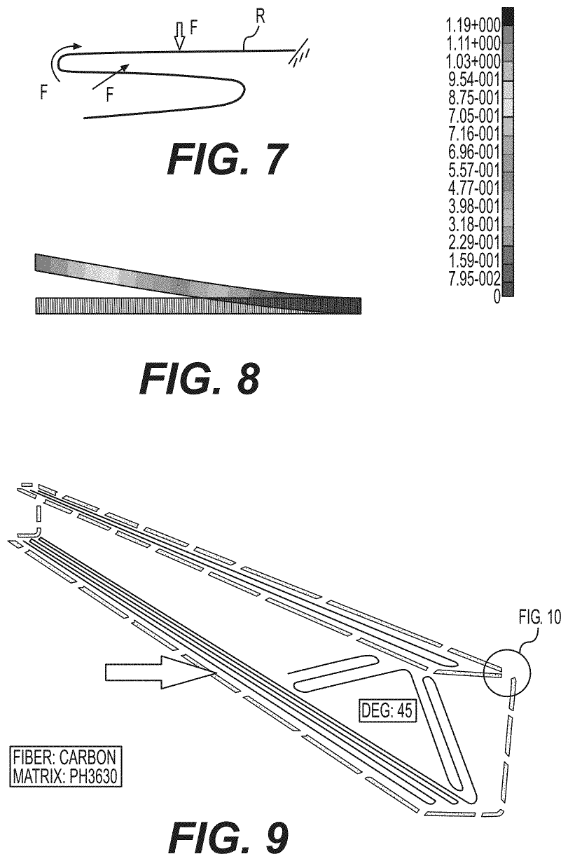

As shown in FIG. 7, the analysis of each reinforcement may be relatively simple. For example, each continuous reinforcement or tow of reinforcements may be considered a composite beam. Based on the constraints and loads of the composite beam, processor 36 may be configured to apply basic engineering equations of mechanics and equilibrium to determine principle stresses, principle strains, and principle directions (e.g., axial forces, shear forces, and bending moments at locations along the lengths of the reinforcements). As shown in FIG. 7, these forces may then be used to determine a selected performance (e.g., strain, stress, etc.) of the reinforcement(s), to determine an aggregated performance of all of the reinforcements, and to display a global performance of structure 12 (Step 260).

The global performance of structure 12 and/or the performance of only individual reinforcements or tows of reinforcements can be shown overlaid with model 52 on display 34. For example, model 52 is shown in FIG. 8 has having a displacement of a particular distance in a direction generally aligned with the applied force directions. In addition, model 52 has been shaded and/or colored in FIG. 8 to illustrate stresses at different locations within structure 12 that are caused by the displacement. In some embodiments, the layout of reinforcements generated at Step 230 may also be shown at this time, in connection with the displacement fields and/or stress fields. It should be noted that, although forces, stress, and strains have been shown and discussed in relation to structure 12 and model 52, heat transfer, electrical flow, electromagnetic radiation, and other performances may be analyzed and displayed by processor 36 in similar manner.

Based on the analysis and/or display of the associated results, the materials selected for and the layout of reinforcements within structure 12 may be considered acceptable or in need of adjustment (Step 270). This consideration may be performed automatically by processor 36, for example by comparing calculated performance results with specified performance criteria, or manually via user observation of the displayed information. When the material selection and the reinforcement layout do not together achieve the specified performance criteria, an adjustment may be made. This adjustment may include changing the selected materials and/or the layout (e.g., density, trajectory, relative positions, etc.) of reinforcements (Step 280).

In one example (e.g., as shown in FIG. 9), the changes are implemented by a user of system 10. For example, the user may be able to push (e.g., via screen-touching or mouse-clicking and dragging) reinforcements, pull reinforcements, disperse (e.g., via a dropdown-window density selection) reinforcements, condense reinforcements, adjust trajectories (e.g., via box-filling of angular and/or dimensional input), select alternative materials, etc. As each of these changes are received, processor 36 may immediately analyze and display the adjusted configuration in near-real time. This near-real time display capability may be available because model 52 of structure 12 may not need to be changed and no elemental meshing may be required. Instead, individual reinforcements may be adjusted by simply adjusting the description of the existing NURBS control points. In some instances, the NURBS curves may need to be broken and/or spliced to achieve the desired adjustments. However, even in these instances, significant time and computing resources are conserved when compared to traditional modeling and FEA.

In another example, processor 36 may be configured to automatically make the changes in material and/or reinforcement layout. For example, for a given location within model 52 of high-stress or strain, processor 36 may be configured to push the reinforcements closer to or further away from the force-application location (referring to FIG. 6), change an orientation and/or density of the reinforcements relative to force vectors through the volume of concern, and/or select another reinforcement (or combination of reinforcements) and/or matrix from a list of available materials.

After completion of Step 280, control may return to Step 250, where the new reinforcement layout and/or the new material selections may be analyzed. Control may repeat through Steps 250-280 until the calculated performance of structure 12 achieves the specified performance criteria.

It is contemplated that, in some embodiments, greater accuracy in the analysis results may be required. In these embodiments, after one or more iterations through Steps 250-280, the type of analysis performed at Step 250 may change. For example, after analyzing performance of structure 12 via “beam analysis” and after adjusting reinforcement trajectories within model 52, processor 36 may be configured to implement isogeometric analysis.

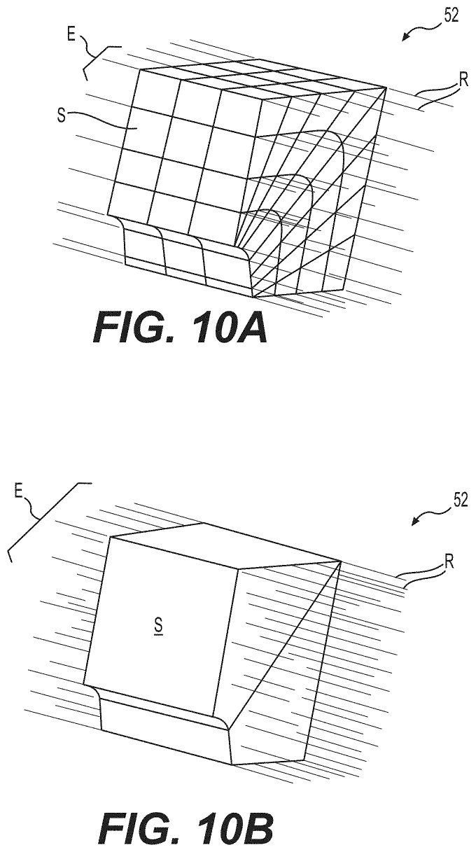

Isogeometric analysis is a computational process, wherein model 52 is defined exactly using NURBS surfaces (e.g., surfaces bounded by NURBS curves—represented in FIGS. 10A and 10B as S). As shown in FIGS. 10A and 10B, the trajectories of the individual reinforcements (labeled as R), that were geometrically described as NURBS curves within model 52 at Step 230 above, constitute at least some of the bounding curves of the NURBS surfaces S within model 52. The NURBS surfaces S are then used to define a plurality of NURBS elements (e.g., 3D elements—represented as E) inside of model 52 that together exactly represent the geometry of structure 12. Processor 36 may apply the engineering equations of equilibrium to determine how each of these elements E transfers loads to adjacent elements E within model 52 and performs under the applied conditions. To achieve greater accuracy in this analysis, the sizes of the 3D elements E may be refined (see greater refinement between FIGS. 10B and 10A), for example by selective movement of the control points and/or modification of the number of control points within the NURBS curves. It should be noted that isogeometric analysis may provide more accurate results than traditional FEA because of the exact representation of structure 12, while reducing a time required for the analysis because the original model 52 of structure 12 may never need to be redefined.

In order to improve accuracy in isogeometric analysis, the properties of each element E may be approximated. In the example of FIG. 10A, each element E has reinforcements R located at outer boarders and a center between the reinforcements R that is generally free of reinforcements R. In other words, one element E is defined within the void between each grouping of adjacent reinforcements R. The reinforcements R, in this example, make the properties of the element E anisotropic. For example, the borders of the element E will be much stiffer in an axial direction of the element (e.g., a stiffness about the same as a known stiffness of the associated reinforcements R) than in a transverse direction, while a center of the element E may have a much lower stiffness (e.g., a stiffness about the same as a known matrix stiffness) that is generally homogenous. Portions of the element E that are located between the borders and the center will have a stiffness that is proportional to a distance between the center and the border.

In the example of FIG. 10B, each element E has reinforcements R located at its borders and passing through its center. Again, this arrangement will make the properties of the element E anisotropic. That is, the boarders will be stiff, as well as other locations throughout the center where additional reinforcements R are located. The areas between reinforcements R will have a lower stiffness, thereby creating multiple areas of graduated stiffness within each element E.

In one embodiment, the stiffness of the element E may be averaged (e.g., based on a volumetric ratio of matrix and reinforcements R within the element E) to generate a magnitude and a trajectory representative of its entire volumetric parameter. This averaged stiffness may then be used during analysis.

In another embodiment, the properties of each element R may be represented in tensorial form to account for the proportionality of location-based properties within each element E.

It should be noted that, while the above process has been described as having a particular sequence of particular steps, some of the steps may be omitted, steps may be added, and the sequence of steps may be adjusted for particular applications. For example, the user of system 10 may be able to choose whether only beam analysis is performed during each iteration of Steps 250-280, whether beam analysis is followed by isogeometric analysis, or whether only isogeometric analysis should ever be performed at Step 250 (i.e., without first performing beam analysis).

Once the calculated performance of structure 12 achieves the specified performance criteria, processor 36 may then generate a tool path for machine 14 (referring to FIG. 1) required to place the reinforcements in the final layout (Step 290). The tool path may be generated in any number of different ways.

In one embodiment, processor 36 may start tool path generation by determining an external surface of structure 12 that should function as a base plane (e.g., which surface may provide a greatest stability for printing). In one example, the surface of structure 12 may be a largest external surface of structure 12 and/or a surface of 12 associated with a greatest density of reinforcements. In another example, flatness of the surface may affect the designation. In yet another example, a center of gravity of structure 12 relative to the surface may affect the designation. It may also be possible for the user of system 10 to select a particular surface of structure 12 as the base plane (e.g., via I/O devices 38).

In another embodiment, the base plane may be selected based on a capacity of machine 14. For example, machine 14 may have a greater reach in a particular direction (e.g., in the Z-direction—referring to FIG. 1), and structure 12 may have a greater dimension along a particular plane (e.g., in the spanwise direction of spar 54—referring to FIG. 4). In this example, the greater dimension of structure 12 may need to be generally aligned with the greater reach direction of machine 14. That is, the interior end of spar 54 may need to be the base plane, such that machine 14 can build in the spanwise direction and still reach the outer tip of spar 54. It should be noted that, in some applications where structure 12 is to be fabricated in-situ (e.g., between mounting locations within a larger existing structure), the selection of a base plane may be unnecessary.

Once the base plane has been determined, processor 36 may be configured to sequence the continuous reinforcements within the base plane for discharge by machine 14. This may be done in many different ways. For example, processor 36 may determine that a longest continuous reinforcement within the base plane should be discharged first, followed by the next longest. Alternatively, processor 36 may determine that a location-specific reinforcement (e.g., a most centrally located reinforcement, an outermost reinforcement, or that a reinforcement continuing from an earlier plane in the sequence) should be generated first. Alternatively, processor 36 may determine that longer reinforcements and/or reinforcements more aligned with the vector field should be generated first, followed by infill of shorter reinforcements and/or reinforcements located between or misaligned with primary vectors in the field.

Once tool paths within the base plane have been sequenced, processor 36 may continue sequencing in association with any reinforcements in a subset that connect with (e.g., are within a proximity threshold of) reinforcements in the base plane. This also may be done in many different ways. For example, processor 36 may again determine that a longest continuous reinforcement within the subset of reinforcements contacting at least one reinforcement in the base plane should be discharged first, followed by the next longest reinforcement in the subset. Alternatively, an innermost reinforcement (e.g., innermost relative to the boundaries of model 52) in the subset may be discharged first. Sequencing may continue in the same general manner, by generating a discharge order for the subset of reinforcements that contact a previously discharged reinforcement, until all reinforcements have been sequenced.

It should be noted that care may be required to ensure that the discharge of one reinforcement does not block access to a discharge location of another reinforcement later in the sequence. It is contemplated that this check may be made after the sequencing of each reinforcement, or all at once after all reinforcements have been sequenced. Blockage may be determined, at least in part, based on known kinematics of machine 14.

In one example the tool path (i.e., the sequence of reinforcements within model 52) may be checked manually, for example by displaying the tool path and allowing the user to accept or reject the path. Alternatively, the check can be made automatically, for example by causing head 20 to follow the tool path (e.g., virtually or in reality without discharging) and monitoring for collisions, reinforcement intersections, boundary deviations, etc. Once the tool path has been accepted (manually and/or automatically), processor 36 may send the tool path to machine 14 in the form of control instructions. It should be noted that, by generating the tool path only after the calculated performance of structure 12 is determined to be acceptable, time and computing resources may be conserved.

In some applications, the discharge of individual reinforcements and/or tows of reinforcements in a manner that achieves performance criteria may not generate an outer surface that meets other expectations. For example, the outer surface may not have a desired appearance, surface texture, hardness, flexibility, etc. In these instances, an outer skinning of structure 12 may be designed and fabricated differently.

For example, after creating a structure 12 that performs in a desired manner, the structure 12 may be covered with one or more layers of material intended to provide a different surface characteristic. The layer(s) may consist of individual reinforcements or tows of a same or different type as the rest of structure 12, or tapes or sheets of unidirectional or pre-woven fabrics. In addition, the layers may be manually applied and/or applied by a head 20 that is specially designed for the particular material. In this example, the user of system 10 may be provided with different options for design and/or fabrication of the outer layers. For example, the user may be able to designate a number of layers, an orientation of layers, a material of the layers, etc.

In some embodiments, processor 36 may be configured to generate the tool path required to place the outer layers and/or to analyze the outer layers for particular desired characteristics. Processor 36 may analyze the outer layers in any manner known in the art. For example, processor 36 may be utilize the boundary element method (BEM). BEM is a numerical computational method of solving for fluid mechanic, acoustic, electromagnetic, fracture mechanic, and other performances at the surface of a modeled structure. BEM is generally computationally more efficient than other methods (e.g., FEA), because it generates a mesh only over the surface rather through a volume of the model. It is contemplated, however, that isogeometric analysis or even traditional FEA could alternatively be utilized to determine the characteristics of the surface layer(s).

It will be apparent to those skilled in the art that various modifications and variations can be made to the disclosed systems and methods. Other embodiments will be apparent to those skilled in the art from consideration of the specification and practice of the disclosed systems and methods. For example, it is contemplated that processor 36 may be configured to directly analyze at Step 250 a vector of control points for each NURBS curve, instead of the curves themselves. This may simplify curve display and/or curve adjustments, thereby reducing computing resources and speeding up the disclosed method.

In another example shown in FIG. 11, an alternative method may be performed by processor 36 during analysis of structure 12 and tool path generation of corresponding tool paths. As can be seen in this figure, this method may include many of the same steps as those shown in FIG. 2. In particular, Steps 200-300 may be substantially identical. However, in contrast to the method of FIG. 2, the method of FIG. 11 shows Step 310 moved to between Steps 250 and 260. That is, the generation of the vector field(s), reinforcement layout, loading application, and analysis of Steps 220-250 may be performed in the transformed space rather than in the original shape of structure 12. This may simplify the operations and reduce the associated computational resources and time.

In addition, as can be seen in FIG. 11, an additional Step 320 may be included within the loop of Steps 250-280. Step 320 may be substantially identical to Step 300, wherein the original shape of structure 12 is again mapped or otherwise transformed into a simpler shape for another round of analysis. It is contemplated that the mapping of Step 320 may be the same mapping occurring at Step 300 or different (e.g., more refined) mapping, as desired.

It is intended that the specification and examples be considered as exemplary only, with a true scope being indicated by the following claims and their equivalents.

What is claimed is:

1. A method of forming a composite structure with an additive manufacturing machine, comprising:
generating a vector field within a virtual model of the composite structure based on anticipated load conditions for the composite structure;
generating a plurality of NURBS curves inside the virtual model that have trajectories at least partially affected by the vector field;
selectively sequencing the plurality of NURBS curves to generate a tool path; and
causing the additive manufacturing machine to discharge a path of composite material along the tool path.

2. The method of claim 1, further including:
without modifying the virtual model, defining a plurality of analytic elements using the plurality of NURBS curves as boundaries of each of the plurality of analytic elements; and
analyzing performance of the virtual model based on the anticipated load conditions using the plurality of analytic elements,
wherein selectively sequencing the plurality of NURBS curves includes selectively sequencing the plurality of NURBS curves based on the performance.

3. The method of claim 2, wherein analyzing performance of the virtual model includes transforming at least one of a shape of the composite structure, the anticipated load conditions, the vector field, and a layout of the plurality of NURBS curves to a canonical shape.

4. The method of claim 2, wherein analyzing performance of the virtual model includes performing isogeometric analysis.

5. The method of claim 4, further including analyzing performance of a surface of the virtual model via boundary element method.

6. The method of claim 2, wherein analyzing performance of the virtual model includes separately analyzing each of the plurality of NURBS curves as a constrained beam based on the anticipated load conditions.

7. The method of claim 6, wherein:
upon determining acceptable performance of the virtual model based on analyzing performance of the plurality of NURBS curves, the method further includes:
without modifying the virtual model, defining a plurality of analytic elements using the plurality of NURBS curves as boundaries of each of the plurality of analytic elements; and
performing a second analysis of the virtual model based on the anticipated load conditions using the plurality of analytic elements; and
selectively sequencing the plurality of NURBS curves includes selectively sequencing the plurality of NURBS curves to generate the tool path based on the second analysis.

8. The method of claim 6, wherein separately analyzing each of the plurality of NURBS curves as a constrained beam includes:
distributing the anticipated load conditions to each of the plurality of NURBS curves based at least partially on proximity to an application site; and
separately analyzing each of the plurality of NURBS curves as a constrained beam based on the distributed load conditions.

9. The method of claim 1, wherein generating the plurality of NURBS curves includes generally aligning the trajectories with the vector field.

10. The method of claim 1, further including:
displaying the performance of the virtual model; and
receiving user input indicative of a desire to change a trajectory of at least one of the plurality of NURBS curves within the virtual model.

11. The method of claim 1, further including automatically adjusting a trajectory of the plurality of NURBS curves based on a capacity of the additive manufacturing machine.

12. The method of claim 1, further including performing topology optimization after generating the vector field and prior to generating the plurality of NURBS curves.

13. The method of claim 1, further including at least one of receiving and generating the virtual model for the composite structure.

14. The method of claim 13, further including at least one of receiving and generating the anticipated load conditions for the composite structure.

15. The method of claim 1, wherein selectively sequencing the plurality of NURBS curves includes:
determining a base plane;
sequencing all of the plurality of NURBS curves at least touching the base plane based on length within a first subset; and
thereafter sequencing all of the plurality NURBS curves touching at least one of the plurality of NURBS curves within the first subset.

16. A method of forming a composite structure with an additive manufacturing machine, comprising:
at least one of receiving and generating a virtual model for the composite structure;
at least one of receiving and generating load conditions for the composite structure;
generating a vector field within the virtual model based on the load conditions;
generating a plurality of NURBS curves inside the virtual model that are generally aligned with the vector field;
without modifying the virtual model, defining a plurality of analytic elements using the plurality of NURBS curves as boundaries of each of the plurality of analytic elements;
analyzing performance of the virtual model based on the load conditions using the plurality of analytic elements;
selectively sequencing the plurality of NURBS curves to generate a tool path based on the performance; and
causing the additive manufacturing machine to discharge a path of composite material along the tool path.

17. The method of claim 16, wherein analyzing performance of the virtual model includes transforming at least one of a shape of the composite structure, the load conditions, the vector field, and a layout of the plurality of NURBS curves to a canonical shape.

18. The method of claim 16, wherein analyzing performance of the virtual model includes performing isogeometric analysis.

19. The method of claim 18, further including analyzing performance of a surface of the virtual model via boundary element method.

20. The method of claim 16, further including performing topology optimization after generating the vector field and prior to generating the plurality of NURBS curves.
